(19) United States
(12) Patent Application Publication
(10) Pub. No.: US 2003/0149672 A1
(43) Pub. Date: Aug. 7, 2003

(54) Apparatus and method for prioritizing opportunities

(75) Inventor: Sarah Laskoski, Ann Arbor, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Global Technologies, Inc., Dearborn, MI (US)

(21) Appl. No.: 09/683,668

(22) Filed: Feb. 1, 2002

(51) Int. Cl. G06F 17/60

(52) U.S. Cl. 705/400; 705/1; 705/10

(57) ABSTRACT

A tool or system is disclosed for evaluating opportunities that rely upon more consistent, direct factors relating to the business of the user and its effect on the business, and which prioritizes opportunities based on a non-monetary value. The tool or system uses a relative analysis between a non-monetary value and documented financial history, such as a balance sheet to prioritize the opportunities entered into the system.

### BACKGROUND OF INVENTION

1. Field of the Invention

The present invention relates generally to an apparatus and method for evaluating a plurality of unique opportunities. More specifically, the present invention relates to an apparatus and method for prioritizing a plurality of opportunities based on a number of unique criteria, including responses to specific sets of questions.

2. Description of the Related Art

In most businesses, many opportunities are presented to the business and the business must decide which of those opportunities it should pursue. For instance, opportunities can be related to licensing, patenting, manufacturing, developing, designing, implementing or other opportunities that require the expenditure of company resources. These resources can include time, money, people, and skill sets. In order to decide which opportunity is most beneficial to the company, a company must investigate each opportunity in order to make a well-reasoned decision.

There are many tools available that purportedly provide methods for valuing or analyzing these opportunities for the purpose needed. For example, one tool is described in patent application Ser. No. US2002/0002524A1 and combines real options theory with data from publicly traded, technology-specific companies to compute reasonable market values for intellectual property that aid buyers and sellers to converge on a fair market value. The valuation model is grounded on the concept that a patent behaves financially as if it were a call option on a future technology asset. Using the Black Scholes formula for call options on stock has become widely accepted, and in the TRRU valuation model, an adaptation of the Black Scholes formula is applied to compute the value of IP using measurable features of the patent or patents on offer, or of values of comparable technologies, in place of the values used for call options on stock. This tool can compute present monetary values relating to a future product, process, or product feature. However, this valuation model offers present and predicted opportunity values based on the inconsistent, volatile nature of the financial world.

There exists a need for a tool or system for evaluating opportunities that rely upon more consistent, direct factors relating to the business of the user and its effect on the business, and which prioritizes opportunities based on a non-monetary value. There further exists a need for a tool or system that uses a relative analysis between a non-monetary value and documented financial history, such as a balance sheet. The present invention provides such a system.

The present invention translates needed information into a relative value or grade, stores the grade with the information, and prioritizes all opportunities based on the grade. Over time, the present invention's relative grading system can be quantified monetarily by comparing grades to financial history of the opportunity. It is an advantage of the present invention that it can be used for intellectual property (“IP”) licensing opportunities. It is a further advantage of the present invention that it can be used for both licensing in and licensing out opportunities. It is also an advantage of the present invention that it separates a second level of grades that speculates strengths and weaknesses of an opportunity, creating a strategy tool.

### SUMMARY OF INVENTION

Accordingly, it is an advantage of the present invention to provide a tool or system for prioritizing opportunities by assigning a relative calculated value to every opportunity to be evaluated. The tool comprises a plurality of modules each having a plurality of value drivers or questions specific to each module. The tool may have any number of unique modules, such as a market module having a plurality of unique value drivers relating to the marketability of the entered opportunity; a cost module having a plurality of value drivers relating to financial needs, implications, and cost feasibility of the entered opportunity; an efficiency module having a plurality of value drivers relating to efficiency of the entered opportunity; and an impact module having a plurality of value drivers relating to overall impact of the entered opportunity on the licensee product and licensee customers. The tool further includes a plurality of user-specified variables, linked to pre-determined weighting factors, in response to the value drivers. The tool of the present invention also includes a processor or other like device which calculates an opportunity value for each entered opportunity by a pre-determined function using the user-specified variables, and then stores the calculated opportunity values for each entered opportunity. The processor or other device also prioritizes the calculated opportunity values. In one embodiment, the tool also comprises a form is published on an accessible information network and which displays at least one of the plurality of value drivers.

The present invention also includes method for prioritizing licensing opportunities by assigning a relative calculated value to every opportunity. The method comprises the steps of: providing at least one module having a plurality of value drivers and providing user-specified variables in response to each of a plurality of value drivers. The method of the present invention also includes the steps of calculating an opportunity value for each entered opportunity using a pre-determined function utilizing the user-specified variables; storing the calculated opportunity values for each entered opportunity; and prioritizing the calculated opportunity values. The method further includes the step of providing pre-determined weighting factors to be applied to each of the plurality of value drivers. In the method of the present invention, the modules may comprise a plurality of unique modules having module-specific value drivers, such as: a market module having a plurality of value drivers relating to the marketability of the entered opportunity; a cost module having a plurality of value drivers relating to financial needs, implications, and cost feasibility of the entered opportunity; an efficiency module having a plurality of value drivers relating to efficiency of the entered opportunity; an impact module having a plurality of value drivers relating to overall impact of the entered opportunity on the licensee product and licensee customers; and an invention module having a plurality of value drivers relating to spin-off ideas, development challenges, and deficiencies of the entered opportunity. The method further includes the step of publishing a form on an accessible information network that displays at least one of the plurality of value drivers.

These and other features and advantages of the present invention will become apparent from the drawings, detailed description and claims that follow.

### BRIEF DESCRIPTION OF DRAWINGS

FIG. 1 is a schematic representation of the system of the present invention.

FIG. 1A is a schematic representation of one method for choosing one type of opportunity to be evaluated with the tool and method of the present invention.

FIGS. 1B-F are schematic representations of value drivers of the present invention for specific modules of one embodiment of the invention.

FIG. 2 is a block flow diagram illustrating the method of the present invention.

### DETAILED DESCRIPTION

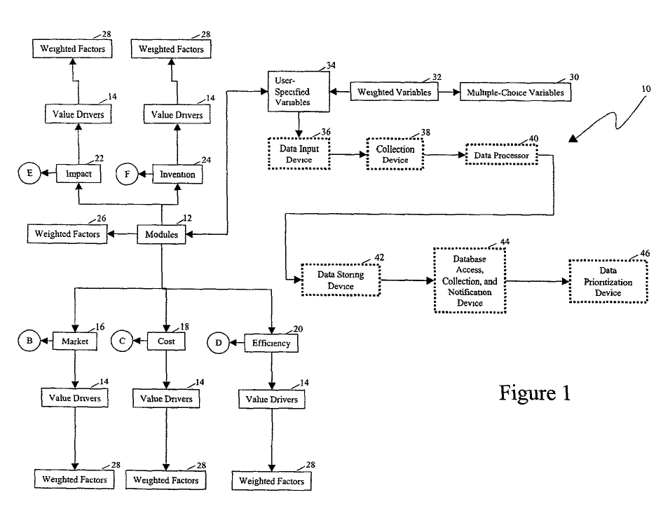

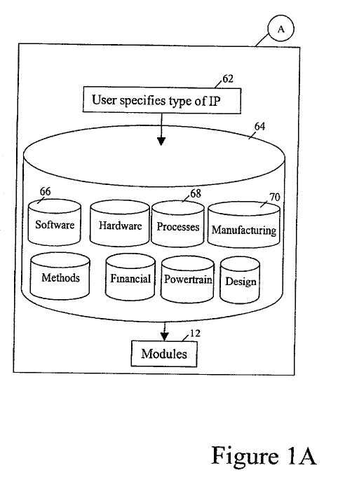

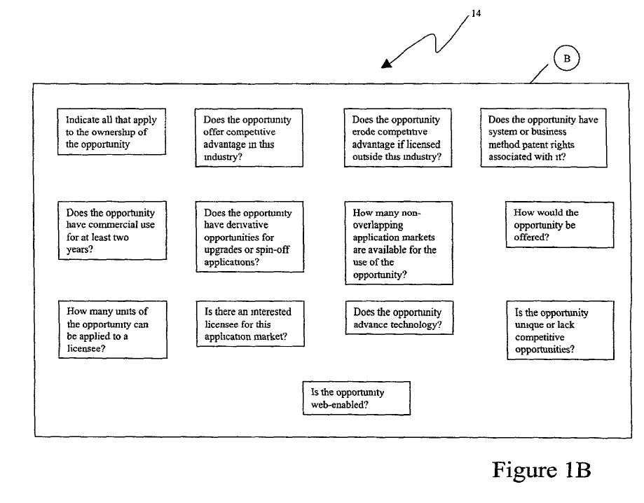

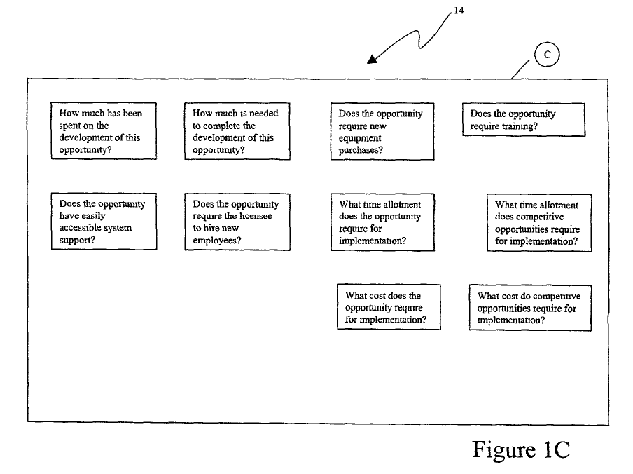

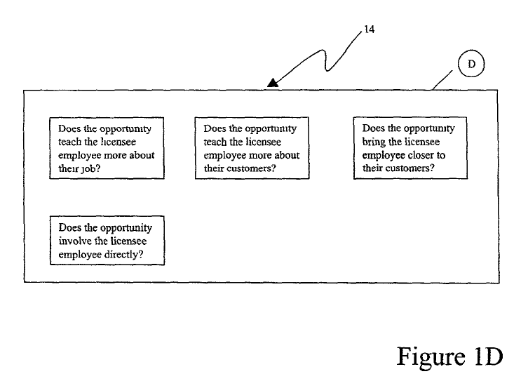

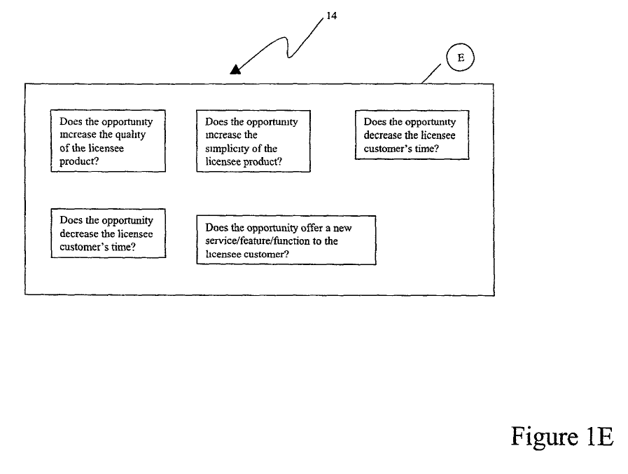

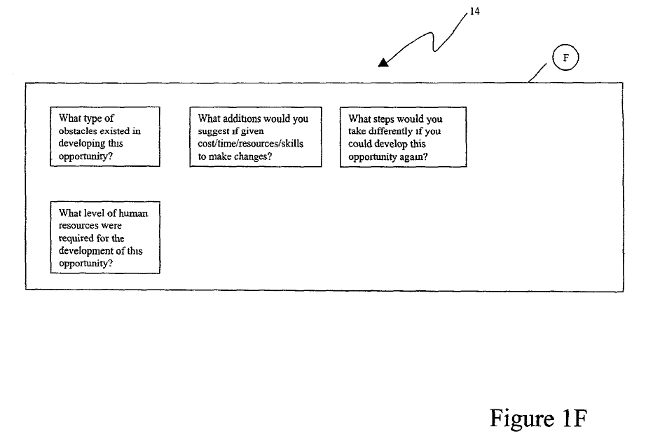

Referring now to the drawings, FIG. 1 shows a schematic representation of the tool or system 10 of the present invention. The tool 10 prioritizes different opportunities entered into it by assigning a relative calculated value to every opportunity entered. “Value” as used herein can either be monetary or non-monetary. The tool has particular application for prioritizing licensing opportunities, especially the licensing of intellectual property. However, the tool or system of the present invention can be used to prioritize any of a number of entered opportunities and is not meant to be limited to prioritizing the licensing of intellectual property. For example, the tool can also be used to evaluate opportunities on a relative basis regarding manufacturability, design use, product purchasing, and other decision-making outfits.

The tool or system 10 can be resident within a microprocessor or available on an accessible information network, such as a shared drive or the Internet. The tool 10 comprises a plurality of modules 12, each including a plurality of value drivers 14. In the preferred embodiment of the present invention, there are five modules 12: a market module 16; a cost module 18; an efficiency module 20; an impact module 22; and an invention module 24. Each module can be assigned a weighting factor 26 by the programmer or user. These weighting factors are assigned based on type of opportunity being evaluated.

Each module includes a unique set of value drivers 14, which will be further described below. Each value driver can be given a weighting factor 28. The weighting factor is dependent upon the type of opportunity being evaluated and is chosen by the programmer or user. Each value driver 14 contains a plurality of multiple-choice variables 30. Each multiple-choice variable can be given a weighting factor 32 by the programmer or user and is dependent upon the type of opportunity being evaluated. The value driver 14 in each module 12 may require a response, chosen by the user. The variables selected by the user are known as user-specified variables 34.

It is the type of opportunity being evaluated that determines each of these weighting factors 26, 28, 32, explained in further detail below. In order to avoid data manipulation, weighting factors are set and cannot be changed by while a user is entering information or once a user has entered an opportunity.

All user-specified variables 34 are submitted to a microprocessor or database or other data input device 36. The database further acts as a collection device 38 for the user-specified variables, although other instruments can be used as collection devices. As a collection device, the database collects the user-specified variables 34 and bins each with its associated value driver. Resident within the microprocessor or database 36 is a plurality of pre-determined math algorithms that use the user-specified variables. These math algorithms contain the value driver weighting factors and/or the module weighting factors. The math algorithms are processed and calculated by a data processor 40. The math algorithms are functions that calculate the total and module scores for each entered opportunity. These total and module scores are stored by a data storing device 42 with each entered opportunity.

After the entered opportunity has been stored a notification device 44 notifies the recipient, such as by email, of the total and module scores. This notification device 44 accesses the database or microprocessor, collects the entered and calculated information, and provides this information to the recipient. A data prioritization device 46, again being a database or microprocessor, then prioritizes all entered opportunities by total score value. This prioritization is available for the recipient to view.

As stated above, the preferred embodiment of the present invention includes five modules: market 16, cost 18, efficiency 20, impact 22, and invention 24. As shown in FIGS. 1B 1F, each of the modules include a plurality of value drivers specific to that module. FIG. 1B shows value drivers relating to the market module 16. These value drivers gather information from the user regarding the quantity of application markets the opportunity reaches, the ownership associated with the opportunity, the derivative or upgrade applications existing for the opportunity, the patent rights associated with the opportunity, and other information relating to marketability of the opportunity. FIG. 1C shows value drivers relating to the cost module 18. These value drivers gather information from the user regarding the cost and time required for development and implementation of the opportunity, the cost and time required for implementation of competitive applications of the opportunity, accessibility of support for the opportunity, costs incurred by taking advantage of the opportunity, and other information relating to the overall cost of the opportunity. FIG. 1D shows value drivers relating to the efficiency module 20. These value drivers gather information from the user regarding the overall affect of the opportunity on those who take advantage of the opportunity. For example, if the opportunity is a leasing software program and a bank is using the opportunity, efficiency value drivers gather information regarding the effect of the leasing software on the bank's employees. Efficiency module value drivers for the given example gather information from the user regarding the level of influence that the opportunity has on the employee, employee job satisfaction, effect on employee resources and skill sets, and other information relating to the overall effect of the opportunity on a user of the opportunity. FIG. 1E shows value drivers relating to the impact module 22. These value drivers gather information from the user regarding the overall effect of the opportunity on the product of those who use the opportunity. In the above example, impact module value drivers gather information regarding the bank's customers and how they are affected by the opportunity, the service or feature or function offered to them, and other related information. FIG. 1F shows value drivers relating to the invention module 24. These value drivers gather information from the user regarding the type of obstacles existing in the development of the opportunity, changes or additions to the opportunity that an inventor may suggest, a hindsight view from the inventor, and other related information. FIGS. 1B-1F are not meant to be a comprehensive list of value drivers for each module, as those skilled in the art may include value drivers more relevant to the specific type of opportunity to be evaluated.

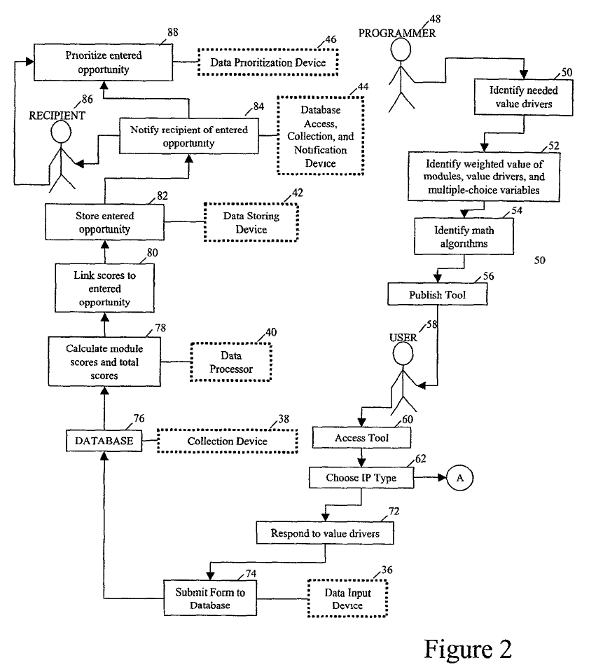

Now the method will be described with reference to FIG. 2. The method begins with a programmer 48 creating a housing mechanism for the modules, value drivers, multiple-choice responses, and all corresponding weighting factors except the module weighting factors. Such a housing mechanism can be a form written in any known program code. The programmer then identifies needed value drivers at 50 by taking the following steps: types of opportunities are defined and assigned different value drivers; assignments are written into the form code; databases are set up for each type of opportunity; each set of value drivers assigned to a type of opportunity is linked to a database specific to that opportunity which are written into the form code.

At 52, the programmer identifies the weighted value of each value driver within each module, and the weighted value of each multiple-choice variable within each value driver. These weighted values are written into the form code. The programmer then identifies the weighted value of each module within each type of opportunity. At 54, the programmer identifies math algorithms that include these weighted values of each module. These math algorithms are written into a database or microprocessor code.

At 56, the programmer publishes the tool of the present invention, which can be the form or other housing mechanism, on an accessible information network such as a shared drive or company intranet or Internet. The form must be published so that a user 58 can access it at step 60. At 62, the user identifies the type of opportunity being evaluated. FIG. 3 shows a method of how the present invention selects the value drivers for each module. This method begins at step 62 when the user selects the type of opportunity. Many different opportunities exist which can be evaluated by the present invention. One type of opportunity is intellectual property (IP). In one example at step 62, the user selects the type of IP. Once the user selects the type of IP the form selects those value drivers needed for the IP submitted by the user, based on the value drivers selected by the programmer for that type of IP. For example, if the user selects a software program assisting with a manufacturing process, then value drivers relating to software 66, process 68, and manufacturing 70 will be shown to the user. The groups of value drivers 64 shown in FIG. 3 are examples but not a complete list of IP groups of value drivers. Once the value drivers are placed into pre-selected modules 12, as determined by the programmer, then they are shown to the user.

The user then responds at 72 to the value drivers by choosing a multiple-choice variable to each of the value drivers. As previously explained, the multiple-choice variables are given a pre-determined weight and are then called a user-specified variable. At 74, the user submits the form or other housing mechanism to the database 76 or other collection device 38. The data, which contains the user-specified variables, is then sent to the data processor 40. At 78, the processor calculates the module scores and total scores. After the scores are calculated, the database links the scores at 80 to the data gathered from the entered opportunity. The database stores each opportunity at 82 using its data-storing device.

After the entered opportunity is stored, a recipient 84 (or group of recipients) is notified at 86 that an opportunity has been entered into the database. At 88, the database prioritizes all entered opportunities based on the calculated total score using the data prioritization device. Once the recipient has received notification, the recipient can view the prioritization of the newly entered opportunity.

1. A tool to prioritize opportunities by assigning a relative calculated value to every opportunity, the tool comprising:
at least one module having a plurality of value drivers;
a plurality of user-specified variables in response to the value drivers; and
a processor operative to calculate an opportunity value for each entered opportunity by a pre-determined function using said user-specified variables, to store the calculated opportunity values for each entered opportunity, and to prioritize the calculated opportunity values.

2. A tool as in claim 1, wherein pre-determined weighting factors are applied to each of the plurality of value drivers.

3. A tool as in claim 1, wherein the at least one module comprises a market module having a plurality of value drivers relating to the marketability of the entered opportunity.

4. A tool as in claim 3, wherein the marketability module includes value drivers relating to ownership of the entered opportunity.

5. A tool as in claim 3, wherein the marketability module includes value drivers relating to available resources to be applied to development of the entered opportunity.

6. A tool as in claim 1, wherein the at least one module comprises a cost module having a plurality of value drivers relating to financial needs, implications, and cost feasibility of the entered opportunity.

7. A tool as in claim 6, wherein the cost module includes value drivers relating to development cost and development time of the entered opportunity.

8. A tool as in claim 6, wherein the cost module includes value drivers relating to implementation cost and implementation time of the entered opportunity.

9. A tool as in claim 1, wherein the at least one module comprises an efficiency module having a plurality of value drivers relating to efficiency of the entered opportunity.

10. A tool as in claim 9, wherein the efficiency module includes value drivers relating to the efficiency of employee job, job knowledge, job tasks, and employee-customer relations for the entered opportunity.

11. A tool as in claim 1, wherein the at least one module comprises an impact module having a plurality of value drivers relating to overall impact of the entered opportunity on the licensee product and licensee customers.

12. A tool as in claim 1, wherein the at least one module comprises an invention module having a plurality of value drivers relating to spin-off ideas, development challenges, and deficiencies of the entered opportunity.

13. A tool as in claim 2, wherein a form is published on an accessible information network and displays at least one of the plurality of value drivers.

14. A tool as in claim 13, wherein the form is operative to submit the plurality of user-specified variables in response to the value drivers to a database for each of the entered opportunity.

15. A tool as in claim 14, wherein the database is operative to store the user-specified variables in response to the value drivers and to calculate a module score for at least one module and a total score for each of the entered opportunity.

16. A tool as in claim 15, wherein the calculated total score is a pre-determined weighted average of the module scores for each of the entered opportunity.

17. A tool as in claim 15, wherein the calculated module score is a pre-determined weighted average of the user-specified variables within a module for each of the entered opportunity.

18. A tool as in claim 15, wherein the database is operative to notify a recipient about the entered opportunity and corresponding total and module scores.

19. A system to prioritize licensing opportunities by assigning a relative calculated value to every opportunity, said tool comprising:
a plurality of modules each having a plurality of value drivers, said plurality of modules comprising:
a market module having a plurality of value drivers relating to the marketability of the entered opportunity;
a cost module having a plurality of value drivers relating to financial needs, implications, and cost feasibility of the entered opportunity;
an efficiency module having a plurality of value drivers relating to efficiency of the entered opportunity; and
an impact module having a plurality of value drivers relating to overall impact of the entered opportunity on the licensee product and licensee customers;
a plurality of user-specified variables, linked to pre-determined weighting factors, in response to the value drivers; and
a processor operative to calculate an opportunity value for each entered opportunity by a pre-determined function using the user-specified variables, to store the calculated opportunity values for each entered opportunity, and to prioritize the calculated opportunity values.

20. A system as in claim 19, wherein the marketability module includes value drivers relating to ownership of the entered opportunity and available resources to be applied to development of the entered opportunity.

21. A system as in claim 19, wherein the cost module includes value drivers relating to development cost, development time, implementation cost, and implementation time of the entered opportunity.

22. A system as in claim 19, wherein the efficiency module includes value drivers relating to the efficiency of employee job, job knowledge, job tasks, and employee-customer relations for the entered opportunity.

23. A system as in claim 19, wherein the at least one module comprises an invention module having a plurality of value drivers relating to spin-off ideas, development challenges, and deficiencies of the entered opportunity.

24. A system as in claim 19, wherein a form is published on an accessible information network, displays at least one of the plurality of value drivers, and is operative to submit the plurality of user-specified variables in response to the value drivers to a database for each entered opportunity.

25. A system as in claim 24, wherein the database is operative to store the user-specified variables in response to the value drivers, to calculate a pre-determined weighted average of the user-specified variables within a module for at least one module score and a pre-determined weighted average of the module scores used for total score determination, and to notify a recipient about the entered opportunity and corresponding total and module scores.

26. A method for prioritizing opportunities by assigning a relative calculated value to every opportunity, the method comprising the steps of:
providing at least one module having a plurality of value drivers;
providing user-specified variables in response to each of a plurality of value drivers;
calculating an opportunity value for each entered opportunity using a pre-determined function utilizing the user-specified variables;
storing the calculated opportunity values for each entered opportunity; and
prioritizing the calculated opportunity values.

27. A method as in claim 26, further including the step of providing pre-determined weighting factors to be applied to each of the plurality of value drivers.

28. A method as in claim 26, wherein the at least one module comprises a market module having a plurality of value drivers relating to the marketability of the entered opportunity.

29. A method as in claim 26, wherein the at least one module comprises a cost module having a plurality of value drivers relating to financial needs, implications, and cost feasibility of the entered opportunity.

30. A method as in claim 26, wherein the at least one module comprises an efficiency module having a plurality of value drivers relating to efficiency of the entered opportunity.

31. A method claim 26, wherein the at least one module comprises an impact module having a plurality of value drivers relating to overall impact of the entered opportunity on the licensee product and licensee customers.

32. A method as in claim 26, wherein the at least one module comprises an invention module having a plurality of value drivers relating to spin-off ideas, development challenges, and deficiencies of the entered opportunity.

33. A method as in claim 27, further including the step of publishing a form on an accessible information network that displays at least one of the plurality of value drivers.

34. A method as in claim 33, wherein the form is operative to submit the plurality of user-specified variables in response to the value drivers to a database for each of the entered opportunity.

35. A method as in claim 34, further including the steps of storing the user-specified variables in response to the value drivers and calculating a module score for at least one module and a total score for each of the entered opportunity.

36. A method as in claim 35, wherein the calculated total score is a pre-determined weighted average of the module scores for each of the entered opportunity.

37. A method as in claim 35, wherein the calculated module score is a pre-determined weighted average of the user-specified variables within a module for each of the entered opportunity.

38. A method as in claim 34, further including the step of notifying a recipient about the entered opportunity and corresponding total and module scores.

39. A method to prioritize licensing opportunities by assigning a relative calculated value to every opportunity, the method comprising the steps of:
providing a plurality of modules each having a plurality of value drivers, the plurality of modules comprising:
a market module having a plurality of value drivers relating to the marketability of the entered opportunity;
a cost module having a plurality of value drivers relating to financial needs, implications, and cost feasibility of the entered opportunity;
an efficiency module having a plurality of value drivers relating to efficiency of the entered opportunity; and
an impact module having a plurality of value drivers relating to overall impact of the entered opportunity on the licensee product and licensee customers;
applying pre-determined weighting factors to each of the plurality of value drivers;
a published form on an accessible information network that displays at least one of the plurality of value drivers;
providing a plurality of user-specified variables, linked to pre-determined weighting factors, in response to the value drivers;
calculating a total score and module scores for each entered opportunity by a pre-determined function using the user-specified variables;
storing the calculated opportunity values for each entered opportunity; notifying a recipient about the entered opportunity and corresponding total and module scores; and
prioritizing the calculated opportunity values.

40. A method as in claim 39, wherein the at least one module comprises an invention module having a plurality of value drivers relating to spin-off ideas, development challenges, and deficiencies of the entered opportunity.

41. A method as in claim 39, wherein the published form is a web enabled, multi-layer form that displays at least one of the plurality of value drivers and is operative to submit the plurality of user-specified variables in response to the value drivers to a database for each entered opportunity.

42. A method as in claim 41, wherein the database is operative to store the user-specified variables in response to the value drivers, to calculate a pre-determined weighted average of the user-specified variables within a module for at least one module score and a pre-determined weighted average of the module scores used for total score determination, and to notify a recipient about the entered opportunity and corresponding total and module scores.
